(19) United States
(12) Patent Application Publication
(10) Pub. No.: US 2008/0195242 A1
(43) Pub. Date: Aug. 14, 2008

(54) Method, Computer Program Product and Apparatus for Configuring a Gauge Display

(75) Inventor: Travis Tidwell, Tulsa, OK (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Navico Inc.

(21) Appl. No.: 11/674,833

(22) Filed: Feb. 14, 2007

(51) Int. Cl. G06F 19/00

(52) U.S. Cl. 700/103; 700/97

(57) ABSTRACT

An apparatus for configuring a gauge includes a gauge building element and a gauge driver. The gauge building element may be configured to receive user selection of one or more characteristics of a gauge at least partially defining at least one of a gauge skin or a indicator skin of the gauge display. The gauge display may include a gauge body and an indicator configured to display a measured operational parameter on the gauge body. The gauge skin defining an appearance of the gauge body, and the indicator skin defining an appearance of the gauge indicator. The gauge driver may be configured to generate a display of the gauge having the at least one of the gauge skin or the indicator skin including the user-selected characteristics defining the at least one of the gauge skin or the indicator skin.

### FIELD OF THE INVENTION

Embodiments of the present invention relate generally to gauges, and more particularly, to providing user customization of the appearance of one or more gauges of a digital gauge panel display.

### BACKGROUND OF THE INVENTION

Given the recent advancements in display technology and the ubiquitous nature of computers and other electronic devices, it is becoming increasingly common for digital devices to replace corresponding analog devices. For example, many vehicles have replaced analog gas and/or speed gauges with corresponding digital gauges. By employing digital devices instead of analog devices, it is often possible to produce at least equal results in terms of gauge accuracy with lower power consumption, lower cost, and less space consumption.

Although digital gauges are popular with some consumers, their popularity is not necessarily universal. Many consumers would prefer to have analog gauges. However, many manufacturers would prefer to avoid providing custom hardware corresponding to user preference with respect to features like gauge type. Furthermore, although designers can create digital gauges to have many different aesthetic characteristics, consumers typically have little or no choice in the aesthetic characteristics of the gauges they purchase. Rather, consumers must choose from available options that are often not highly customizable.

It may therefore be desirable to develop a gauge that appeals to a number of different consumers by introducing flexibility in the look and feel of the gauge. It may further be desirable to develop a gauge that is customizable by consumers.

### BRIEF SUMMARY OF THE INVENTION

Accordingly, in order to provide a customizable gauge that may cure the deficiencies noted above, exemplary embodiments of the present invention provide a method, computer program product and apparatus for configuring the appearance of one or more gauges of a digital gauge panel display. As is known to those skilled in the art of computing, a skin may be defined as a customized appearance of a user interface of a software program. Exemplary embodiments of the present invention employ a gauge building function that allows a user to select and fully customize a skin of one or more gauges of a digital gauge panel display. Thus, the gauge panel display may be customizable by user selection of one or more characteristics of one or more gauges from among existing options, and/or by user selection of one or more characteristics of one or more gauges that may be designed and/or imported by the user.

In one exemplary embodiment, a method for configuring a gauge is provided. The method includes receiving user selection of one or more characteristics of a gauge at least partially defining at least one of a gauge skin or a indicator skin of the gauge display. The gauge display may include a gauge body and an indicator configured to display a measured operational parameter on the gauge body. The gauge skin may define an appearance of the gauge body, and the indicator skin may define an appearance of the gauge indicator. The method may further include generating a display of the gauge having the at least one of the gauge skin or the indicator skin including the user-selected characteristics defining the at least one of the gauge skin or the indicator skin.

In another exemplary embodiment, a computer program product for configuring a gauge is provided. The computer program product includes at least one computer-readable storage medium having computer-readable program code portions stored therein. The computer-readable program code includes multiple executable portions. A first executable portion is for receiving user selection of one or more characteristics of a gauge at least partially defining at least one of a gauge skin or a indicator skin of the gauge display. The gauge display may include a gauge body and an indicator configured to display a measured operational parameter on the gauge body. The gauge skin may define an appearance of the gauge body, and the indicator skin may define an appearance of the gauge indicator. A second executable portion is for generating a display of the gauge having the at least one of the gauge skin or the indicator skin including the user-selected characteristics defining the at least one of the gauge skin or the indicator skin.

In yet another exemplary embodiment, an apparatus for configuring a gauge is provided. The apparatus includes a gauge building element and a gauge driver. The gauge building element may be configured to receive user selection of one or more characteristics of a gauge at least partially defining at least one of a gauge skin or a indicator skin of the gauge display. The gauge display may include a gauge body and an indicator configured to display a measured operational parameter on the gauge body. The gauge skin defining an appearance of the gauge body, and the indicator skin defining an appearance of the gauge indicator. The gauge driver may be configured to generate a display of the gauge having the at least one of the gauge skin or the indicator skin including the user-selected characteristics defining the at least one of the gauge skin or the indicator skin.

Exemplary embodiments of the invention may provide users with an ability to select the skin of each gauge and the position, size, etc. of the gauge within a digital gauge panel display. As a result, the user may customize a gauge panel display to a very high degree without significantly increasing hardware or software overhead for manufacturers and designers.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a basic block diagram illustrating a marine system that may benefit from exemplary embodiments of the present invention;

FIG. 2 illustrates a basic block diagram of a head unit according to an exemplary embodiment of the present invention;

FIG. 3 illustrates a functional block diagram of an apparatus for providing a skinable gauge according to an exemplary embodiment of the present invention;

FIG. 4 illustrates an example of a skinable gauge panel according to an exemplary embodiment of the present invention;

FIG. 5 illustrates a skinable gauge according to an exemplary embodiment of the present invention; and

FIG. 6 is a flowchart according to an exemplary method of providing a skinable gauge according to one embodiment of the present invention.

### DETAILED DESCRIPTION OF THE INVENTION

Embodiments of the present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like reference numerals refer to like elements throughout.

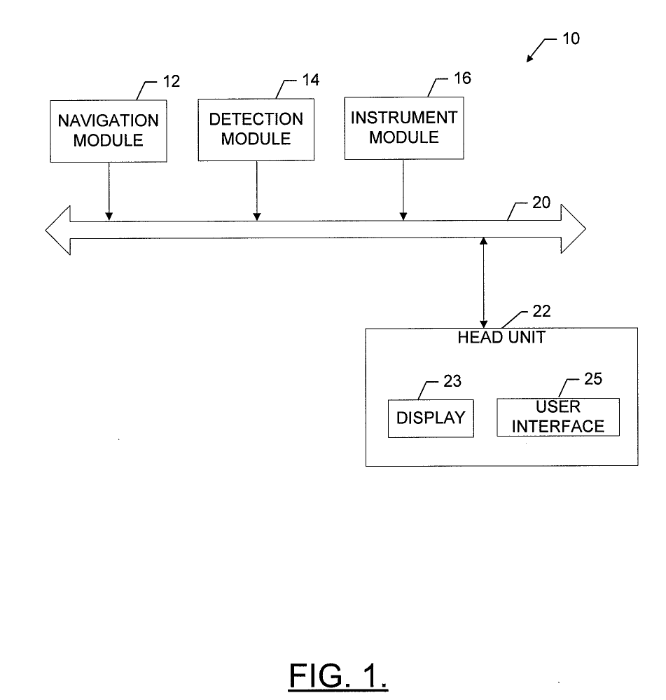

FIG. 1 is a basic block diagram illustrating a marine system that may benefit from exemplary embodiments of the present invention. Although shown and described herein with respect to a marine system, embodiments of the present invention may also be employed in numerous other environments such as, for example, automobiles, video games, simulation devices, aircraft, other vehicles, etc. It should therefore be understood that a marine system is shown and described herein for purposes of explanation and not of limitation.

As shown in FIG. 1, a marine system 10 may include a number of different modules, each of which may comprise any device or means embodied in either hardware, software, or a combination of hardware and software configured to perform one or more functions. For example, the marine system may include a navigation module 12, a detection module 14, an instrument module 16 and/or numerous other peripheral devices. One or more of the modules may be configured to communicate with one or more of the other modules, and/or with a head unit 22 that may be configured to process and/or display data, information or the like from one or more of the modules. The modules and/or head unit may be configured to communicate with one another in any of a number of different manners including, for example, via a network 20. In this regard, the network 20 may be any of a number of different communication backbones or frameworks including, for example, the NMEA 2000 framework. The head unit 22 may include a display 23 and a user interface 25.

The navigation module 12 may include any of a number of different navigation devices configured to receive navigation information from one or more external sources and generate location information indicative of the location of, for example, a marine craft employing the marine system 10. For example, the navigation module 12 may include one or more GPS (global positioning system) or other satellite navigation system modules, inertial navigation system modules, terrestrial navigation system modules (e.g., LORAN-C), etc.

The detection module 14 may include any of a number of different detection and ranging systems for detecting vessels, structures or aids to navigation. For example, the detection module 14 may include a conventional sonar system that uses sound wave transmissions to determine water depth or detect fish and/or other waterborne contacts. Additionally or alternatively, for example, the detection module 14 may include a conventional radar system that uses radio frequency transmissions to determine ranging information and other position related information associated with surface or airborne vessels or aids to navigation.

The instrument module 16 may be configured to receive analog or digital information related to a parameter measured at a particular device, and communicate that information to the network 20 in a digital format. For example, the instrument module 16 may be configured to receive information from numerous sensors configured to measure parameters at numerous corresponding shipboard devices such as fuel level, speed, engine RPM (revolutions per minute), engine fluid temperature and/or pressure, battery state of charge, etc. The instrument module 16 may therefore include any of a number of different devices such as, for example, a tachometer, speedometer, thermometer, pressure gauge, volt meter, fuel level sensor, etc. Where applicable, the instrument module 16 may include analog-to-digital conversion capabilities to communicate digital data to the network 20.

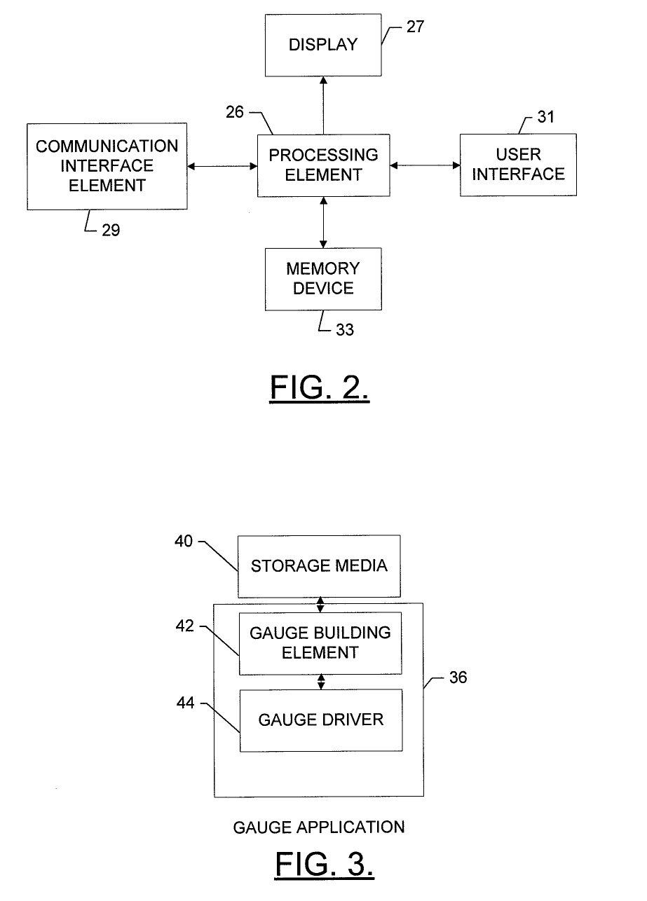

As indicated above, the head unit 22 may be configured to receive data, information or the like via the network 20 and process and/or display the received data. FIG. 2 illustrates a basic block diagram of the head unit 22 according to an exemplary embodiment of the present invention. As shown in FIG. 2, the head unit 22 may include a processing element 26, a display 27, a communication interface element 29, and a user interface 31. The head unit 22 may also include a memory device 33 having, for example, volatile or non-volatile memory. The memory device may be configured to store information, data, applications, instructions or the like for enabling the head unit to carry out various functions in accordance with exemplary embodiments of the present invention. For example, the memory device could be configured to buffer input data for processing by the processing element 26. Also, for example, the memory device could be configured to store a gauge application, as will be described in greater detail below. Additionally or alternatively, the memory device 33 could be configured to store other data including, for example, image data, as will also be described in greater detail below.

The processing element 26 may be embodied in many ways. For example, the processing element 26 may be embodied as a processor, a coprocessor, a controller or various other processing means or devices including integrated circuits such as, for example, an ASIC (application specific integrated circuit). In an exemplary embodiment, the processing element 26 may be configured to execute instructions stored in the memory device 33 or otherwise accessible to the processing element 26. In an exemplary embodiment, the processing element 26 may be configured to execute a gauge application stored in the memory device 33 or otherwise accessible to the processing element 26. Meanwhile, the display 27 may be, for example, a conventional LCD (liquid crystal display) or any other suitable display known in the art upon which images may be rendered.

The communication interface element 29 may be embodied as any device or means embodied in either hardware, software, or a combination of hardware and software that is configured to receive and/or transmit data from/to the network 20. The user interface 31 may include, for example, a keyboard, keypad, function keys, mouse, scrolling device, touch screen, or any other mechanism by which a user may interface with the head unit 22.

Reference is now made to FIG. 3, which illustrates a functional block diagram of an apparatus for configuring the appearance of one or more gauges of a digital gauge panel display in accordance with exemplary embodiments of the present invention. As shown and described herein, the apparatus may be embodied in any of a number of different devices configured to carry out the functions of the apparatus, as explained herein. In one exemplary embodiment, for example, the apparatus may be embodied in the head unit 22. It should be understood, however, that any of a number of other devices may alternatively embody the apparatus including, for example, a further processing device (including, e.g., a processing element, memory device, etc.) in communication with one or more of the modules 12, 14, 16 and/or head unit 22 via the network 20, as shown in FIG. 1.

As shown in FIG. 3, the apparatus of one exemplary embodiment includes a storage media 40, a gauge building element 42 and a gauge driver 44. The storage media 40 may be any memory including, for example, the memory device 33, configured to store data such as image data. The gauge building element 42 and gauge driver 44 may be embodied as any devices or means embodied in either hardware, software, or a combination of hardware and software. In one exemplary embodiment, for example, the gauge building element 42 and gauge driver 44 may be embodied as software forming a gauge application 36.

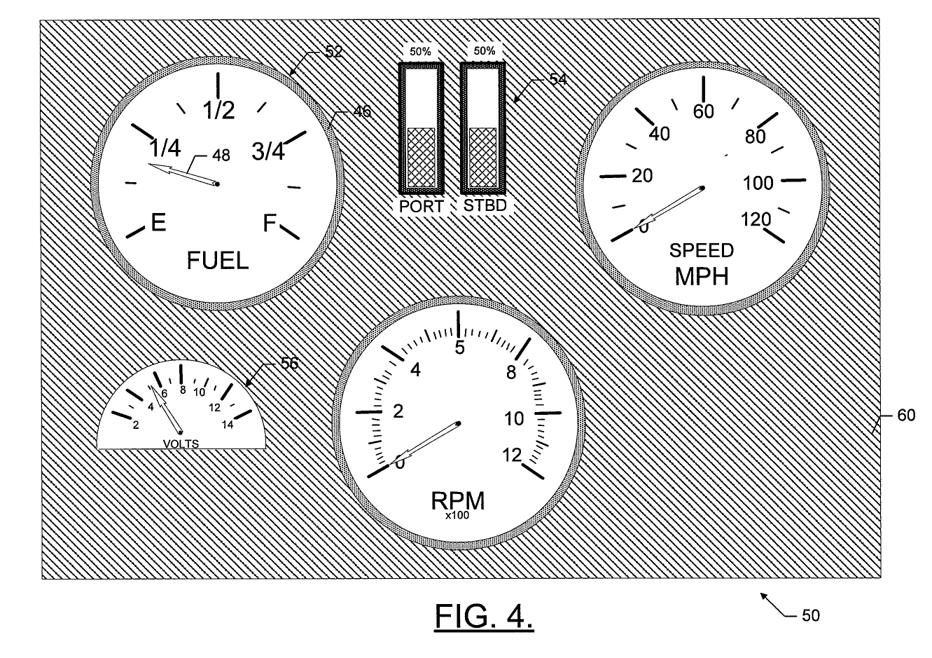

The gauge building element 42 may be configured or otherwise adapted to configure a skinnable gauge of a digital gauge panel display in response to user selected criteria. For example, the gauge building element 42 may be configured to receive one or more user selections of one or more characteristics of a gauge and produce a digital display of a gauge based on the user-selected characteristics. As will be appreciated, a gauge may include a gauge body with a graduated scale or dial, and an indicator (e.g., needle) for indicating the quantity of a measured parameter on that scale or dial. Thus, in an exemplary embodiment, the gauge building element 42 may be configured to receive user selection of a gauge skin 46 defining a customized appearance of a gauge body, and/or an indicator skin 48 defining a customized appearance of a gauge indicator (see FIG. 4). The gauge building element 42 may also receive user selections regarding gauge construction including the measured parameter indicated by the gauge, the gauge type, position, etc.

The gauge driver 44 may be configured to generate a digital gauge panel display including one or more skinnable gauges, one or more of which may be individually driven in accordance with information corresponding to a parameter associated with each respective gauge. For example, the gauge driver 44 may be configured to receive input information from the instrument module 16 and thereafter drive a gauge (e.g., deflect a needle) to correspond to the input information. FIG. 4 shows an example of a skinnable gauge panel display 50 according to an exemplary embodiment of the present invention. In this regard, the skinnable gauge panel display 50 may include a digital representation of a plurality of gauges, at least some of which may be customized by utilization of the gauge building element 42 during construction of the corresponding gauges. As such, FIG. 4 shows an example of a digital representation of analog gauges in which the display characteristics of the gauges may be alterable in accordance with user selected display characteristics. As shown in FIG. 4, the plurality of gauges may include gauges of different types such as, for example, a circle gauge 52, a slider gauge 54 and a half-moon gauge 56. Although only three different types of gauges are shown in FIG. 4, any number of gauges of any of a number of different types may be included among the plurality of gauges. Thus, for example, in addition to the circle gauge, slider gauge and half-moon gauge, or in lieu of one or more of the foregoing gauges, the gauge panel display may include one or more differential gauges (e.g., differential tachometer gauge, etc.).

Each of the plurality of gauges may indicate measurement of a respective parameter. For example, as shown in FIG. 4, the circle gauge 52 may be a fuel gauge, the slider gauge 54 may be an engine power gauge, and the half-moon gauge 56 may be a voltage gauge. As also shown in FIG. 4, the gauges may also reflect measurements of other parameters including, but not limited to, boost, speed, RPM, etc. For both the circle gauge 52 and the half-moon gauge 56, an indicator (e.g., needle) may be deflected according to an input signal indicative of an operating parameter associated with the gauge. For example, a sensor in a fuel tank may produce a signal corresponding to a half-full fuel tank. The instrument module 16 may receive and communicate the signal to the apparatus (e.g., head unit 22). In turn, the gauge application 36 of the apparatus may receive the signal such that the gauge driver 44 may generate a gauge based on one or more gauge characteristics defined by the user via the gauge building element 42, and having an indicator (e.g., needle) deflection based on the signal.

As indicated above and shown in FIG. 4, the gauge building element 42 may be configured to receive user selection of a gauge skin 46 and/or an indicator skin 48. It should be noted that although reference numeral 46 appears to be pointing to the border of the circle gauge 52, the gauge skin 46 of FIG. 4 may refer to one or more display characteristics of a gauge body in addition to or in lieu of its border. However, a gauge may have a separate indicator skin 48 that refers to one or more display characteristics of the indicator of a gauge, if appropriate.

The gauge skin 46 of one or more of the gauges may be defined by any of a number of different characteristics including the color, shape and size of the border and/or background of a gauge body. Other characteristics that define the gauge skin 46 may include, for example, units, max/min, optimum operating range, operating limit (e.g., redline), major and minor divisions of the scale or dial of the gauge body, and other gauge text. In an exemplary embodiment, the gauge skin 46 may be defined by the user based upon user selections input into the gauge building element 42. The user may therefore select each of the characteristics described above in order to build or construct each of the gauges according to the user's custom specifications or desires. The indicator skin 48 may also be defined by characteristics including the color, shape and size of the indicator (e.g., needle), the orientation of the indicator, and/or visual effects associated with the indicator (e.g., shadows or other three-dimensional (3D) effects, etc.).

In an exemplary embodiment, one or more, if not all, aspects of the gauge skin 46 and/or indicator skin 48 (one or more display characteristics of a gauge body and/or indicator) may be user selectable. In various instances, then, the gauge skin 46 and the indicator skin 48 may both be fully customized by the user. For example, the gauge building element 42 may be utilized to select an image for use as a portion of the gauge skin 46 and/or the indicator skin 48. In this regard, an image could be selected for use as a gauge body including any gauge border and background coloration, and could include units and major/minor divisions (e.g., tick marks) of a scale or dial of the gauge body. In this regard, the image selected for use as the gauge body could represent that of a conventional analog or digital gauge body. As another alternative, an image could simply be selected for use as the border of the gauge body. For example, an image selected for use as the border of the gauge body could be an animal's head in which the open mouth of the animal forms the border. Alternatively, an image selected for use as the border of the gauge body could be any other object having an opening for forming the border. In an alternative example, an image could be selected for use as the background, or a combination of the background and the border, of the gauge body. In yet another example, an image of a logo or other ornamental display could be selected for use as a portion of the gauge body or indicator. Additionally, a user selected design (image) could be selected for use as all or a portion of the gauge indicator. For example, an image selected for use as all or a portion of a gauge indicator could be a sword, a particular arrow design, or the like.

The image selected for use as a portion or all of a gauge body or indicator could be, for example, an image from a library stored in the storage media 40. The library could be a fixed group of images previously stored in the storage media, or the library may be routinely updatable with new images. In other words, the user may import additional images or even design personal images. In this regard, the image could be stored in the storage media 40 by the user subsequent to obtaining the image by any mechanism available. For example, the image could be downloaded from the internet or created by the user using a camera or any other means of creating an image. As yet another alternative, the image need not be stored in the storage media 40, but may instead be accessed by the gauge building element 42 by any known method. For example, the image could be directly retrieved from a camera, an external storage device, a web address, etc. In an exemplary embodiment, the image could be a GPX file, a JPEG file, an XML file, a GIF file or any other suitable format for an image file.

In an exemplary embodiment, the gauge building element 42 of the gauge application 36 may be accessed via a gauge setup screen. The gauge set up screen may include various options for creating a gauge. As stated above, options may be available for selecting the type of gauge and the parameter to be associated with the gauge. Options may also be available for other aspects or characteristics of the gauge. The options may be provided via any suitable method, such as via any method including drop down menus, text entry, etc. As an example, a drop down menu may be provided for selecting a particular operational parameter to be associated with a particular gauge type. In this regard, the drop down menu (e.g., options) may be provided based upon which operational parameters are capable of receipt by the gauge application 36. In other words, the gauge application 36 may provide options for operational parameters to be associated with a gauge based on a determination of which operational parameter inputs are receivable from the instrument module 16.

For a number of different display characteristics, the user may select options related to the gauge skin 46 as defined by the respective gauge characteristics. For example, the user may be provided with options for characteristics such as gauge size, border, background, divisions, indicator orientation (e.g., indicator center and max/min deflection angles), units, major/minor divisions (including the number of minor divisions between each major division), scale, etc. Some options for various characteristics are described below, but are not all inclusive. For example, gauge type options could include circular, half-moon, slider, differential, etc. Gauge parameter options could include any operational parameters available from the instrument module 16. In other words, as stated above, the gauge building element 42 may be in communication with the instrument module 16 to determine which options to present to the user in relation to gauge parameter options. Scale options could include, for example, a percent scale (e.g., 0 to 100%), a fractional scale (e.g., empty, ¼, ½, ¾, and full), or a discrete value scale. Major/minor division options could include selections related to the number of minor divisions between each major division. Any of the characteristics could include an option for obtaining an image related to the particular characteristic. Alternatively, the entire gauge skin could be defined by a single image. Additionally, a default setting could be an option associated with each characteristic. Accordingly, if no option is selected, or if the default option is selected, a corresponding default characteristic may be associated with the respective gauge characteristic. In one example, a circular gauge type could be selected to be associated with a speed parameter. A discrete value scale could then be selected with a minimum value of 0 and a maximum value of 120. Indicator orientation could be selected in order to define the indicator origin at the center of the circular gauge and the maximum and minimum angle corresponding to the maximum and minimum speed values, respectively, could then be selected. The units could be selected as miles-per-hour (MPH) and major/minor tick marks could be selected with or without corresponding text values displayed on a linear scale. An image could be selected (e.g., from the storage media 40) to correspond to either or both of the border and background of the gauge.

If desired, the indicator skin 48 may additionally or alternatively be selected in a manner similar to that of the gauge skin 46. For example, an image could be selected to correspond to the indicator (e.g., needle) and the image could be oriented as desired by the user. In an exemplary embodiment, the indicator skin 48 (or the gauge skin 46) could be defined to have animated or 3D characteristics. For example, a GIF file can be animated to show such characteristics as indicator shadowing or other 3D effects. Animation and 3D characteristics may be exhibited at all times of operation, or only during selected times. For example, the user may define the indicator skin 48 such that the indicator has a standard appearance of a black arrow during normal operation, but the indicator skin 48 may change to a red arrow in response to a particular threshold being reached. Characteristics of the gauge skin 46 may also be changed in response to an indicator position reaching the particular threshold. In other words, the user may utilize the gauge building element 42 to define a particular threshold at which characteristics of either the indicator skin 48 or the gauge skin 46 may be changed automatically. Thus, for example, if the speed exceeds a selected threshold such as the speed limit, a change in a characteristic of either the indicator skin 48 or the gauge skin 46 may occur. In response to the speed being reduced below the speed limit, the characteristic may return to normal.

In an exemplary embodiment, a wallpaper 60 of the skinnable gauge panel display 50 may also be user selected. In this regard, the user may select the wallpaper 60 to correspond to a particular image or that may be stored in the memory device 33 or otherwise accessible (e.g., by download) to the gauge application 36. For example, the wallpaper 60 could correspond to a conventional wood-grain panel, a metallic panel, or many other user selectable panel styles.

In an exemplary embodiment, once the wallpaper 60 is either selected or determined by default, and the gauge is defined as described above, the user may define a size and position of the gauge in the skinnable gauge panel display 50. For example, the user may be enabled to drag and drop the gauge at a desired location within the skinnable gauge panel display 50. Additionally, the user may be enabled to stretch and/or shrink the gauge to fit a desired size. Alternatively, the size and location of the gauge may be defined by the user by utilizing option selections during construction of the gauge.

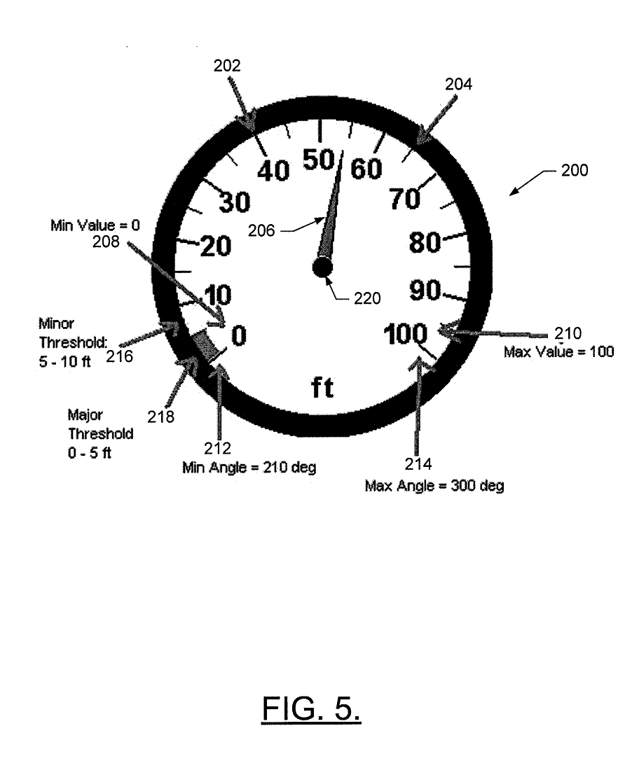

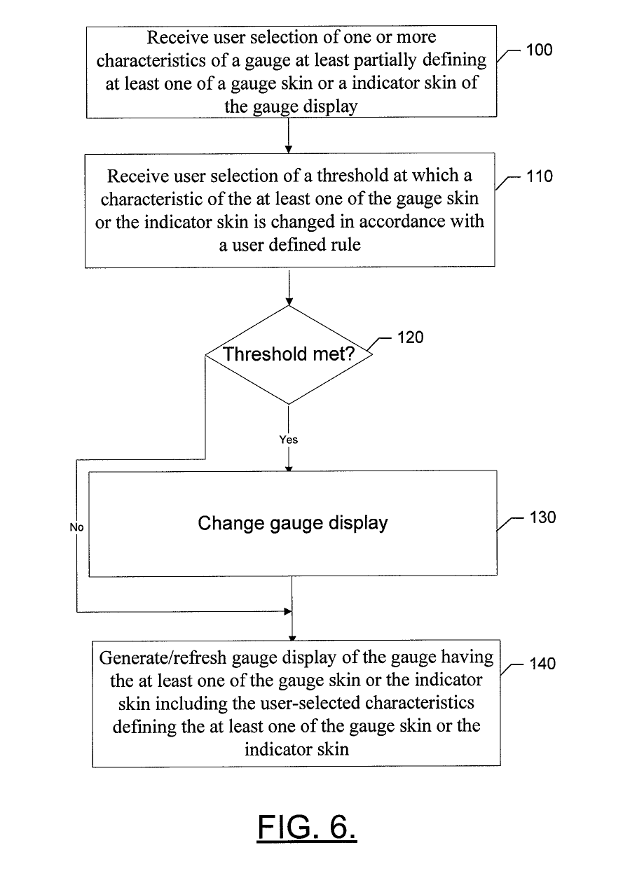

FIG. 5 illustrates a skinnable gauge according to an exemplary embodiment of the present invention. In this regard, FIG. 5 illustrates an example of information which may be provided to the gauge driver 44 to enable driving of the gauge configured by the gauge building element 42. As shown in FIG. 5, a gauge 200 may include major ticks 202, minor ticks 204, a needle 206, a maximum gauge value 208, a minimum gauge value 210, a maximum gauge angle 212, a minimum gauge angle 214, a minor threshold range 216 and a major threshold range 218 each of which may be defined at the gauge building element 42. In an exemplary embodiment, characteristics of the gauge 200 may be included in an XML file which defines the geometry of the image used to display the gauge so that the indicator (e.g., the needle 206) may be properly driven based on the geometry of the image.

In an exemplary embodiment, the needle 206 may include characteristics that are defined in terms of a needle length, which determines a length of an indicator forming the needle 206, and a needle center 220, which may be defined as an x,y coordinate of a fulcrum of the needle 206. Alternatively, the needle center 220 may be defined in a polar coordinate system and the needle length may then be defined by a single radial value. A needle direction defining, for example, clockwise or counter-clockwise needle motion may also be defined using the gauge building element 42. Other information which may be provided, for example, in the XML file may include the maximum gauge value 208, which defines a maximum value of the gauge 200, and the minimum gauge value 210, which defines the minimum value of the gauge. The maximum gauge angle 212 defines the angle at which the maximum gauge value resides on the digital face plate. The minimum gauge angle 214 defines the angle at which the minimum gauge value resides on the digital face plate. Major ticks 202 determine when a corresponding value should be displayed over the range of the gauge. For example, on a depth gauge measuring depth in feet in which the minimum depth is 0 and the maximum depth is 100 feet, if a major tick interval is defined to be 10 feet, a major tick will occur every ten feet over the range from 0 to 100 feet (e.g., 10, 20, 30, etc.). Minor ticks 204 determine the frequency of ticks on the gauge over the range of the gauge. For example, on a 0 to 100 ft depth gauge, if a minor tick interval is defined to be 5 feet, a minor tick will occur every five feet over the range from 0 to 100 ft. The gauge 200 may also include the minor threshold range 216 which defines an area of interest with respect to a minor threshold. For example, depths between 5 and 10 feet may represent an increased risk of grounding and therefore a corresponding portion of the gauge may include a color change or other indication that the minor threshold has been reached. The gauge 200 may also include a major threshold range 216 which defines an area of interest with respect to a major threshold. For example, depths between 0 and 5 feet may represent an imminent risk of grounding and therefore a corresponding portion of the gauge may include a color change or other indication that the major threshold has been reached. The XML filed may also define image size and a bezel thickness, which determines a thickness of the bezel of the gauge 200.

FIG. 6 is a flowchart of a system, method and program product according to an exemplary embodiment of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the head unit and executed by a built-in processor in the head unit. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

As shown in FIG. 6, one embodiment of a method of configuring a digital gauge may include receiving user selection of one or more characteristics of a gauge at least partially defining at least one of a gauge skin or a indicator skin of the gauge display at operation 100. The gauge display may include a gauge body and an indicator configured to display a measured operational parameter on the gauge body. The gauge skin may define an appearance of the gauge body. The indicator skin may define an appearance of the gauge indicator. In an exemplary embodiment, operation 100 may include receiving user selection of an image for use as at least a portion of the at least one of the gauge skin or the indicator skin. In another embodiment, operation 100 may include receiving user selection of one or more characteristics defining a gauge skin, the user-selected one or more characteristics including at least one of a gauge type or receiving user selection of a gauge minimum and maximum value and corresponding minimum and maximum indicator deflection angles. Alternatively, operation 100 may include receiving user selection of an indicator origin or receiving user selection of a parameter to be associated with the gauge.

Irrespective of the exact manner of receiving a user selection defining a gauge skin or a indicator skin, the method may further include an optional operation of receiving user selection of a threshold at which a characteristic of the at least one of the gauge skin or the indicator skin is changed in accordance with a user defined rule, as indicated at operation 110. For example, the user defined rule may be input via the gauge setup screen in the form of a Boolean expression such as “IF speed>55, THEN change indicator skin to red arrow.”After defining the gauge skin or indicator skin, and after selecting a threshold for changing the gauge skin or indicator skin, a determination may be made at operation 120 as to whether the threshold is met. If the threshold is met, the gauge display may be changed at operation 130. If not, the gauge display may not be changed. Finally, at operation 140, the gauge may be generated or refreshed having the gauge skin or the indicator skin.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for configuring a gauge including a gauge body and an indicator, the method comprising:
receiving user selection of one or more characteristics of a gauge at least partially defining at least one of a gauge skin or a indicator skin of the gauge display, the gauge display including a gauge body and an indicator configured to display a measured operational parameter on the gauge body, the gauge skin defining an appearance of the gauge body, and the indicator skin defining an appearance of the gauge indicator; and
generating a display of the gauge having the at least one of the gauge skin or the indicator skin including the user-selected characteristics defining the at least one of the gauge skin or the indicator skin.

2. The method of claim 1, wherein receiving the user selection comprises receiving user selection of an image for use as at least a portion of the at least one of the gauge skin or the indicator skin, and wherein generating the display comprises generating a display of the gauge including the user-selected image.

3. The method of claim 1, further comprising receiving user selection of a threshold at which a characteristic of the at least one of the gauge skin or the indicator skin is changed in accordance with a user defined rule.

4. The method of claim 1, wherein receiving the user selection comprises receiving user selection of one or more characteristics defining a gauge skin, the user-selected one or more characteristics including at least one of a gauge type, a parameter to be associated with the gauge, a scale, units, a background, a border, or gauge divisions.

5. The method of claim 1, wherein receiving the user selection comprises receiving user selection of a gauge minimum and maximum value and corresponding minimum and maximum indicator deflection angles.

6. The method of claim 1, wherein receiving the user selection comprises receiving user selection of an indicator origin.

7. The method of claim 1, wherein receiving the user selection comprises receiving user selection of a parameter to be associated with the gauge, the parameter being selected from available inputs from instruments in communication with a device generating the gauge.

8. A computer program product for configuring a gauge, the computer program product comprising at least one computer-readable storage medium having computer-readable program code portions stored therein, the computer-readable program code portions comprising:
a first executable portion for receiving user selection of one or more characteristics of a gauge at least partially defining at least one of a gauge skin or a indicator skin of the gauge display, the gauge display including a gauge body and an indicator configured to display a measured operational parameter on the gauge body, the gauge skin defining an appearance of the gauge body, and the indicator skin defining an appearance of the gauge indicator; and
a second executable portion for generating a display of the gauge having the at least one of the gauge skin or the indicator skin including the user-selected characteristics defining the at least one of the gauge skin or the indicator skin.

9. The computer program product of claim 8, wherein the first executable portion includes instructions for receiving user selection of an image for use as at least a portion of the at least one of the gauge skin or the indicator skin, and wherein generating the display comprises generating a display of the gauge including the user-selected image.

10. The computer program product of claim 8, further comprising a third executable portion for receiving user selection of a threshold at which a characteristic of the at least one of the gauge skin or the indicator skin is changed in accordance with a user defined rule.

11. The computer program product of claim 8, wherein the first executable portion includes instructions for receiving user selection of one or more characteristics defining a gauge skin, the user-selected one or more characteristics including at least one of a gauge type, a parameter to be associated with the gauge, a scale, units, a background, a border, or gauge divisions.

12. The computer program product of claim 8, wherein the first executable portion includes instructions for receiving user selection of a gauge minimum and maximum value and corresponding minimum and maximum indicator deflection angles.

13. The computer program product of claim 8, wherein the first executable portion includes instructions for receiving user selection of an indicator origin.

14. The computer program product of claim 8, wherein the first executable portion includes instructions for receiving user selection of a parameter to be associated with the gauge, the parameter being selected from available inputs from instruments in communication with a device generating the gauge.

15. An apparatus system for configuring a gauge, the apparatus comprising:
a gauge building element configured to receive user selection of one or more characteristics of a gauge at least partially defining at least one of a gauge skin or a indicator skin of the gauge display, the gauge display including a gauge body and an indicator configured to display a measured operational parameter on the gauge body, the gauge skin defining an appearance of the gauge body, and the indicator skin defining an appearance of the gauge indicator; and
a gauge driver configured to generate a display of the gauge having the at least one of the gauge skin or the indicator skin including the user-selected characteristics defining the at least one of the gauge skin or the indicator skin.

16. The apparatus of claim 15, wherein the gauge building element is further configured to receive user selection of an image for use as at least a portion of the at least one of the gauge skin or the indicator skin, and wherein generating the display comprises generating a display of the gauge including the user-selected image.

17. The apparatus of claim 15, wherein the gauge building element is further configured to receive user selection of a threshold at which a characteristic of the at least one of the gauge skin or the indicator skin is changed in accordance with a user defined rule.

18. The apparatus of claim 15, wherein the gauge building element is further configured to receive user selection of one or more characteristics defining a gauge skin, the user-selected one or more characteristics including at least one of a gauge type, a parameter to be associated with the gauge, a scale, units, a background, a border, or gauge divisions.

19. The apparatus of claim 15, wherein the gauge building element is further configured to receive user selection of a gauge minimum and maximum value and corresponding minimum and maximum indicator deflection angles.

20. The apparatus of claim 15, wherein the gauge building element is further configured to receive user selection of an indicator origin.

21. The apparatus of claim 15, wherein the gauge building element is further configured to receive user selection of a parameter to be associated with the gauge, the parameter being selected from available inputs from instruments in communication with a device generating the gauge.
